(19) United States
(12) Patent Application Publication
(10) Pub. No.: US 2005/0043885 A1
(43) Pub. Date: Feb. 24, 2005

(54) Data processing system for provisioning transit stops uin a transmit system

(75) Inventor: Patrick Michael Amlinger, Mississauga (CA)

Correspondence Address: MARKS & CLERK, P.O. BOX 957, STATION B, OTTAWA, ON, K1P 5S7, CA

(73) Assignee: Daytech Mfg. Ltd., Toronto (CA)

(21) Appl. No.: 10/495,493

(22) PCT Filed: Nov. 13, 2002
(86) PCT No.: PCT/CA02/01748

(30) Foreign Application Priority Data
Nov. 13, 2001 (CA) 2,361,858

(51) Int. Cl. G01C 21/28

(52) U.S. Cl. 701/204

(57) ABSTRACT

A data system for provisioning transit stops in a transit system is such that each transit stop has its own unique identity. The data system includes a central computer, at least a microprocessor at each transit stop, first communication means at each transit stop, second communication means on each transit vehicle, a security activator at each transit stop and annunciator means at each transit stop to provide visual and/or audible announcements. The central computer analyses the present location or driving condition data for any specific transit vehicle, and transmits data to a specific transit stop concerning the then estimated arrival time of a specific transit vehicle at that specific transit stop, at any instant in time, in real time. The central computer is adapted to receive a signal indicating an emergency situation at any specific transit stop at any instant in time, and to notify public authorities of that emergency situation.

### FIELD OF THE INVENTION

This invention relates to systems for administering the functions of a transit system through data collected from transit stops and shelters. This invention further relates to the collection of information from and dissemination of information to a plurality of transit stops and shelters. This invention still further relates to transit stops and shelters provided with network components for collection of data therefrom, and the provisioning thereof. Finally, the present invention relates to a system for providing estimated time of arrival of transit vehicles to transit stops and shelters, and for ensuring the security of the transit stops and shelters as well as the transit riders thereat.

### BACKGROUND OF THE INVENTION

Transit stops and shelters of different dimensions, construction and design are well known. Generally speaking these transit shelters are made of pre-manufactured components that are assembled in situ and installed such that the shelter is fixed to the ground.

Systems for administering transit systems are also well known. Many transit administration systems comprise automatic vehicle location (“AVL”) means for detecting the location of the vehicles comprising the transit system, and administering the transit fleet using this location information.

There is a need to provide data provisioning to transit stops and shelters. One aspect of such data provisioning is providing up-to-date data regarding the arrival times of transit vehicles to riders waiting at a particular transit shelter. Another aspect is providing means for assuring the safety and security of transit stops and shelters, and any transit riders who may be awaiting the arrival of a transit vehicle at any stop or shelter.

One particular solution for providing up-to-date arrival time data at a transit stop is disclosed in U.S. Pat. No. 5,739,774, issued to Olandesi et al on Apr. 14, 1998, which discloses a system comprising a plurality of stop units that collect and disseminate information related to vehicle arrivals at the transit stops. The stop units are linked by means of a communication link to a suitable communication network such as a low power RF communication network. Via this network, the stop units are further linked to a computing means. The stop units communicate the arrival and departure time of transit vehicles to the computing means for the purpose of calculating the probable arrival time of the transit vehicles at stop units further down a particular transit route.

One of the disadvantages of the Olandesi et al invention is that the system disclosed does not provide means for collecting and disseminating data from transit vehicles between transit stops. Where a transit vehicle has encountered a traffic jam between stops, for example, there is a need to collect information between transit stops and disseminate this information to transit stops.

An earlier patent issued to Lewiner et al, U.S. Pat. No. 5,461,374, issued Oct. 24, 1995, describes a system for informing users of a bus network about the waiting time for buses at stops in the network. However, the system is particularly concerned with determining the distance between each bus in the system, and the distance between those buses and the next stop. Data concerning the approximate waiting time for an approaching bus is displayed at bus stops.

Schmier et al, U.S. Pat. No. 6,006,159, issued Dec. 21, 1999, also provides a system for notifying passengers who are waiting for the public transit vehicles of the status of that vehicle. A central processor or a computer is coupled to a globe positioning determining device for receiving and analyzing the locations of vehicles; and the vehicle status and other information including news and advertisements are made available for public access such as by pagers, notebook and palm computers, telephones, and the like.

Another patent issued to Lewiner et al, U.S. Pat. No. 6,097,317, issued Aug. 1, 2000, concerns itself with a portable appliance which informs users about waiting times by providing a radio receiver, an interrogation key pad, a central unit which evaluates the estimated time of arrival of the next bus at a particular stop, and a screen for displaying the waiting time for that bus. A sound emitter is provided, so that if the estimated time of arrival differs excessively from the time of arrival initially estimated the last time the appliance was interrogated by the user, a sound alarm or signal is given.

Decaux et al, U.S. Pat. No. 6,253,148, issued Jun. 26, 2001, teaches a system similar to that referred to immediately above, where users are informed about waiting times for buses at stops in a bus network. Receivers are adapted to calculate waiting times for buses, based on the present position of the bus, and calculations are made having regard to average length of travel time from that position to the next stop. A central computer broadcasts estimated positions that the buses are expected to occupy at a particular instance in time to receivers that are established for that purpose.

Jones U.S. Pat. No. 6,278,936, issued Aug. 21, 2001, is interested more in providing travel data transmitted from vehicles that are monitored by a system, to user who request that travel information. The users require to submit a request to the data manager, who then responds with the appropriate information.

However, a disadvantage of the prior art is that it particularly in the case of delays caused by traffic jams, the transit vehicle drivers themselves are a source of important information affecting updated estimated arrival times further down a particular transit route. In other words, additional reasoned input beyond automatically calculated data is sometimes required.

Another disadvantage of the prior art is that it does not provide means for collecting information from transit stops other than information regarding the arrival and departure of transit vehicles from transit stops. Advertising and marketing revenue has increased in importance to transit operators. Prior solutions for provisioning transit stops do not provide adequate means for maximizing revenue from advertising and marketing sources by collecting data from riders at transit stops.

Furthermore, known solutions do not provide means for data feedback from alarms, security sensors, proximity detectors and the like. A still further disadvantage is that known solutions do not provide means for collecting data required to process payment transactions from transit stops.

There is a need, therefore, for a system for provisioning transit stops wherein estimated transit vehicle arrival time is provided to transit stops, especially when based on data collected from transit vehicles in transit between transit stops along a transit route.

For purposes of the following discussion, the words transit stop and transit shelter are used interchangeably. However, a distinction may be drawn between those terms, in that a transit stop may be considered to be a designated spot such as a corner or the like, or traffic island, where transit vehicles are scheduled to stop to embark and disembark passengers. A transit shelter is the same except that a covered and sometimes enclosed structure is provided for purposes of sheltering transit riders, who are waiting for the arrival of a transit vehicle, from rain or snow, wind, and the like. However, any of the following discussion is equally applicable to a transit stop or a transit shelter; and particularly the apparatus and physical installation of devices at a transit stop or a transit shelter requires, in any embodiment of the present invention, that the apparatus and other display means and the like, as described hereafter, which will be found at any transit stop or transit shelter are placed or located into a secure, tamper-proof, enclosure. That enclosure might be such as a pillar or obelisk placed at a transit stop, or it might be a panel or a corner element found in a transit shelter.

### SUMMARY OF THE INVENTION

In any event, the present invention provides a data system for provisioning transit stops in the transit system with data concerning estimated arrival time of a transit vehicle at a specific transit stop or shelter, or in the transit system comprises a plurality of transit vehicles. Each transit vehicle has its own unique identity. There is a plurality of specific transit stops, at which any specific transit vehicle is scheduled to stop from time to time.

The principal components of the data system in keeping with the present invention comprise a central computer, a least a microprocessor at each individual transit stop or shelter, first communication means at each transit stop or shelter, second communication means on each transit vehicle, a security actuator at each transit stop or shelter, and annunciator means at each transit stop or shelter.

The microprocessor at each individual transit stop or shelter has its own identity, whereby each transit stop or shelter has its own unique identity.

The first communication means at each transit stop or shelter is adapted to communicate with the central computer so as to selectively send data thereto and receive data therefrom.

The second communication means on each transit vehicle is adapted to communicate with the central computer so as to transmit data thereto which are indicative of the present location or driving conditions for each specific transit vehicle at any instance in time.

The security actuator at each transit stop is adapted to transmit a signal to the central computer that an emergency situation exists at that respective transit stop or shelter, when actuated.

The annunciator means at each transit stop or shelter is adapted to provide visual and/or audible announcements to transit riders thereat.

Thus, the central computer is adapted to analyze the present location or driving conditions data for any specific transit vehicle and to transmit data to a specific transit stop or shelter concerning the then estimated arrival time of a specific transit vehicle to that specific transit stop or shelter, at any instant in time.

Also, the central computer is adapted to receive a signal indicating an emergency situation at any specific transit stop at any instant in time, and to notify public authorities of that emergency situation.

Each of the microprocessor, first communication means, security actuator, and annunciator means, for any specific transit stop or shelter, are located in a secure tamper-proof enclosure.

As noted, the enclosure may be integrally associated with a transit shelter.

At least selected transit vehicles in the transit system, if not all such vehicles, are equipped with GPS apparatus so as to have real time updating of their present location.

At least selected transit stops or shelters may be equipped with a microphone and a voice annunciator, so that two-way voice communication can be conducted between any such selected transit stop or shelter and an operator who is present at the central computer.

Also, communication between any transit stop or shelter and the central computer may be by any communication method which may be chosen from the group consisting of wired telephone communication, radio-operated wireless communication, mobile telephone communication, and computer network communication. Each transit stop therefore has a unique telephone number or IP address, as necessary.

Any transit stop or shelter may be equipped with at least one further security or rider amenity feature which may be chosen from the group consisting of vibration sensors to sense vibration as a consequence of vandalism or accident, impact sensors to sense motion as a consequence of vandalism or accident, surveillance cameras, video cameras, proximity sensors to sense the presence of persons in the immediate vicinity of the respective transit shelter, controllable beacons, controllable illumination lamps, video display means, alphanumeric display means, and mixtures and combinations thereof.

At transit shelters which have enclosures as part of their structure, glass breakage sensors may also be provided.

Any transit stop or shelter may further comprise a rider presence indicator which indicates to the driver of an approaching transit vehicle that at least one rider awaits the arrival of that transit vehicle at that specific transit stop or shelter.

Also, any transit stop or shelter may further comprise means for providing or receiving fare vouchers or specific fare payments from transit riders at that transit stop or shelter.

Still further, any transit stop or shelter in keeping with the present invention may comprise annunciator means to indicate the imminent arrival of a transit vehicle at that transit stop or shelter.

Video or alphanumeric display means may be provided at any transit stop or shelter, where such display means is adapted to display schedule information of transit vehicles which are intended to come to that transit stop or shelter, where display is under the control of the microprocessor at the transit stop or shelter, and the central computer. Accordingly, schedule information for transit vehicles whose arrival at any transit stop or shelter is imminent, may be updated by the central computer in real time.

Any transit stop or shelter in keeping with the present invention may also further comprise an air quality sensor for sensing and analyzing ambient air in the immediate vicinity of that transit stop in real time.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a system resource chart illustrating the resources of the system of the present invention.

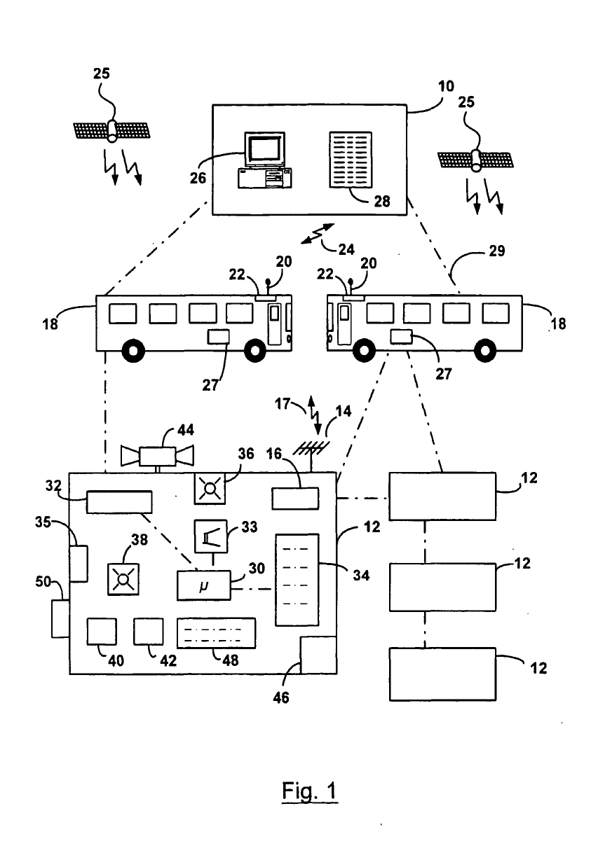

### DETAILED DESCRIPTION OF THE PREFERRED EMBODIMENT

The novel features which are believed to be characteristic of the present invention, as to its structure, organization, use and method of operation, together with further objectives and advantages thereof, will be better understood from the following discussion.

The system of the present invention comprises a communication network 10. The present invention further comprises a plurality of transit stops or shelters 12. Each transit stop or shelter 12 of the present invention comprises a known transmitter 14 and receiver 16 for communicating with the communication network 10 in association with a communication link 17, provided in a manner that is known.

Typically, the communication network 10 is a wireless network, but it might be wired because the communication link 17 may be a wired link or a wireless link. Such links will typically comprise wired telephone communication using an existing telephone installations and infrastructure, or mobile telephone communications using existing mobile or cellphone installations and infrastructure. The communication link 17 may also be a radio-operated wireless communication link, especially in rural areas. The unique identity for each transit stop 12 may therefore be such as a telephone number which has been assigned to that transit stop or shelter.

Moreover, the communication link 17 may be by way of a LAN or WAN computer network. In that case, each transit stop or shelter will have a unique IP address within that computer network; and communication between and among the transit shelters and a central computer 26 may be wired or wireless, or both. Reference to “wired” communication herein, of course, contemplates fibre optic communication.

It should be understood that the present invention contemplates the use of transit shelters, but also transit stops that do not comprise a shelter construction. The disclosure, however, refers primarily to transit shelters because most transit operators are likely to implement the present invention in regard to transit shelters.

The transit vehicles 18 of the transit system also comprise a transit vehicle transmitter 20 and transit vehicle receiver 22 as well as a transit vehicle communication link 24, also provided in a manner that is known.

In accordance with the present invention, wireless communication network 10 comprises means for locating 25 the transit stops 12 and particularly the transit vehicles 18 and displaying their respective locations in a local coordinate system. This is achieved using, for example, known Global Positioning Systems (“GPS”) in a manner that is well known. In the preferred embodiment of the present invention, therefore, the transit vehicles 18 are provided with a GPS transmitter 27. The location of the transit vehicles 18 is provided in real time to the satellites of the GPS system. This location data is in turn provided to a ground radio tower (not shown), which location data is then transferred to a central computer 26 provided at, for example, the transit system dispatch centre.

In accordance with the present invention, the central computer 26, transit shelters 12 and transit vehicles 18 are further connected to data communication network 29 (shown in chain line), in a manner that is also known.

The central computer 26 is adapted to compare the progress of transit vehicles 18 provided by the GPS network as described above, with their scheduled position in accordance with the transit schedule.

The wireless communication network 10 may be associated with a known display system 28 for displaying scheduled and actual position of the transit vehicles on the transit grid, to operators who are present at the transit system dispatch centre, in a manner that is known.

Any transit shelter 12 may further comprises a microprocessor 30 for controlling data provisioning of the transit shelter 12, as well as the collection from the transit shelter 12 and communicating this data to the central computer 26. It should be understood that the present invention provides means for two-way communication between the central computer 26 and the transit shelters 12. The microprocessor 30, in the preferred embodiment of the present invention, may typically comprise a hardware device having a CPU and memory. The microprocessor 30 is linked to the various devices described in this invention, in a manner that is known, by means of known hardware interfaces. The microprocessor 30 is provided with instructions for controlling a plurality of associated devices, for example by means of firmware. In addition, the microprocessor 30 of the present invention is further adapted to receive instructions from central computer 26 via the communication network 10 and data communication network 29, for executing instructions to the devices. This permits the central computer 26 to issue new instructions, or update instructions, to the plurality of microprocessor 30 on the transit grid in response to new factors affecting provisioning to transit shelters 12.

Any transit shelter 12 may further comprise a communication interface 32 connected to the microprocessor 30 for communicating messages to the transit riders. This communication interface 32 comprises a suitable display means 34 such as an LED banner, flat screen or the like. The transit shelter 12 further comprises a known voice annunciator 33 for communicating with transit riders. Voice annunciator 33 is particularly important in terms of providing information to transit riders who are visually impaired.

The display means 34 and voice annunciator 33 are adapted to display data provided by the central computer 26 via the data networks 10 and 19.

The communication interface 32 provides means for displaying information regarding estimated arrival time of transit vehicles to the shelter display means 34.

Communication network 10 provides means for obtaining information from the drivers of transit vehicles to update estimated arrival time data. This information is obtained by communication of signals corresponding to the cause of delay and likely time period of delay using known manual or voice activated key input devices, in a manner that is known. This information is processed by central computer 26 in a manner that is also known so as to estimate arrival times along the transit route. This information is then communicated to the transit shelters 12 and displayed on their respective display means 34. In order to efficiently administer the transit system, it is preferred that the data feedback from the transit drivers be obtained electronically. If further information is required in certain cases, the dispatch centre can contact the transit drivers. It is contemplated by the invention therefore, that the input devices provided to the transit drivers be adapted to permit the transit drivers to input messages describing predetermined variables affecting transit vehicle arrival time. These messages are understood by central computer 26 and processed in accordance with known AVL systems to update estimated arrival times in the transit grid. For example, an input of “A5” may signify: delay due to traffic jam, estimated delay to the next stop equal to 5 minutes.

It is also important to note that, in keeping with a particular provision of the present invention, any transit stop or shelter 12 is equipped so as to provide for the safety, and security of transit riders who are present or in the vicinity of that transit stop or shelter. Accordingly, each transit stop or shelter is equipped with a security actuator 40, which may be rider activated or which may be automatically connected to other sensors present at the transit stop or shelter 12 to sense vibration, glass breakage, or the like. Accordingly, the security actuator 40 provides automatic means to notify operators who are present and on duty at the central computer 26 of any emergency situation such as vandalism or accident that may be detected or noted in manners discussed hereafter, or as a consequence of the actuation of such as a security button which is manually depressable by a transit rider or other individual at or in the immediate vicinity of any transit stop or shelter 12.

Thus, vandalism, accidents, or the need for other emergency assistance, may be communicated to the central computer 26 and to operators who are at the central computer 26, and they in turn will deploy security personnel, inform the police, or otherwise notify the public authorities of whatever emergency situation exists at the specific transit stop or shelter 12 that caused the alarm to be made.

Another aspect of the present invention, is that the microprocessor 30 and display means 34 permits the central computer 26 to push data to the transit shelters 12 in addition to transit vehicle arrival time. This data includes news updates, public service announcements, and advertising in the form of audio/video advertising.

The transit shelters 12 of the present invention also permit the microprocessor 30 to act as a gateway for administering other aspects of provisioning to the transit shelters. For example, transit shelters can be provided with means for delivering goods or services to riders. For example, known ticket dispensers can be provided at the transit shelters 18. Microprocessor 30 provides means for permitting electronic payment for tickets, as central computer 26 can be interfaced with known credit card processing systems or other payment systems, in a manner that is also known. Microprocessor 30 is used to complete the authorization loop at such ticket dispensers. Microprocessor 30 also provides means to interoperate with Bluetooth™ technology or other similar technology thereby permitting payment using known wireless devices, in a manner that is also known.

Microprocessor 30 also provides means for collecting additional data from additional devices that provide data input at the transit shelters of the present invention.

For example, the transit shelter 12 may further comprise a known sensor means 35 for detecting the presence of riders in the transit shelter. This sensor means 35 is connected to an indicator means 36 for indicating the presence of the rider or riders to the driver of the transit vehicle 18. In prior art transit shelters often riders go unnoticed by transit drivers and therefore transit drivers fail to stop for riders. This may cause significant dissatisfaction with the affected transit riders. This is particularly common when the weather is such that transit riders are likely to remain inside the transit shelter and where visibility is poor from the perspective of the transit driver, for example, in heavy rain, or in relatively cold weather when the panes of transit shelters can become frosted, thereby restricting the ability of the transit driver to see transit riders inside the transit shelters.

Thus, the indicator means 36 may comprise a light indicator preferably mounted in an elevated position on the side wall of the transit shelter 12 proximate to the transit vehicle's path, or on the roof of the transit shelter 12. This is to improve the transit driver's sight lines of the light indicator.

Alternatively, the indicator means 36 may provide a signal to the microprocessor 30 which in turn communicates a signal that a rider is present in the transit shelter, or in its vicinity, to the wireless communication network 10. A signal is sent in turn to the receiver 22 of the transit vehicle en route to the particular transit shelter 12 to alert the transit driver of the presence of transit riders.

Moreover, the sensor means 35 at any transit shelter 12 may function to increase or decrease the illumination in the immediate area of the transit shelter, depending on whether the presence or absence of a transit rider is noted. Thus, as a transit rider approaches or enters a transit shelter, for example, the level of the illumination within the transit shelter will increase; and when transit riders are noted to be in the shelter then the level of illumination automatically be decreased. Likewise, especially during cool or cold weather, in climate weather, and the like, radiant heater within a shelter may be turned on or off by a sensor means 35. Such control of illumination and heat sources provided an obvious savings in energy consumption and costs.

Still further, any transit shelter 12 may also comprise a proximity indicator means 38 that is adapted to alert passengers within the transit shelter and also in the vicinity of the transit shelter 12 that a transit vehicle's arrival at the transit shelter is imminent. This is to encourage transit riders to make their way to the transit vehicle's usual stop position prior to the transit vehicle's arrival thereto. This in turn promotes efficient boarding of transit vehicles. Also, for transit riders on their way to the transit shelter while the arrival of the transit vehicle to the transit shelter is imminent, the proximity indicator means 38 gives these transit riders advance notice of the arrival of the transit vehicle. This makes it less likely that transit riders will miss the transit vehicle by informing them of the need to accelerate movement to the transit shelter in advance of the imminent arrival of the transit vehicle.

Because vandalism is a costly fact of life, particularly in urban regions where transit systems are most likely to be part of the social infrastructure, any transit shelter 12 may be further provided with known vandalism sensors 42 adapted to detect the occurrence of a vandalism event. For example, vandalism sensors 42 may comprise known vibration detectors and/or glass break detectors. Vandalism sensors 42 are also adapted to collect information and provide this information to the central computer 26 via the communication networks 10 and 19. This information can be used to initiate appropriate third party responsive action, just as in response to triggering of alarm 40.

Any transit shelter 12 may be further provided with one or more known video cameras 44, having audio and video capability connected to the microprocessor 32. The video cameras 44 are adapted to record events in the transit shelter, or in its vicinity, and communicate the recorded images and audio to the central computer 26 via the central computer 26 and the wireless communication network. The present system will permit the control of the video cameras 44 to record these events in accordance with protocols established by the transit authority or regulators in light of issues such as privacy. These protocols may permit constant recording by the video camera 44, or alternatively, only upon the triggering of the alarm 40 or of vandalism sensors 42, as explained below.

The microprocessor 30 is also adapted to send images from specific video cameras 44 in response to a request from the central computer 26. This functionality is provided in a manner that is well known. Thus, various video cameras 44 that may be part of the present system are provided with an IP address on the communication networks 10 and 19. The request for transfer of images from a specific camera 44 comprises an electronic mail that includes the IP address of the specific video camera 44 that is communicated to the microprocessor 30 at the transit shelter 12 where that video camera 44 is located. The microprocessor 30 then turns on that video camera 44 and transfers images therefrom to the central computer 26. The transit operator using the central computer 26 can also direct the movement of the video camera 44 by sending similar electronic messages to the microprocessor 30 of the present invention to swivel or turn the video cameras 44 on a remote basis, in a manner that is known. In this way, the present invention provides means for engaging a live audio and video link on a remote basis.

This transfer of images from video cameras 44 at a specific transit shelter 12 to the central computer 26 is also triggered by the engagement of alarm 40. The images requested by central computer 26 can then be transferred to police vehicles or downloaded by police vehicles, in a manner that is also well known. This is to assist in the apprehension of individuals who may have perpetrated a criminal offence inside or in the vicinity of the transit shelter 12.

Transit shelters 12 in keeping with the present invention may further comprise known rider counting means 46. The rider counting means 46 are adapted to count the number of riders entering the transit shelters 18 of the present invention and/or who wait in the vicinity of the transit shelter 12. This information is provided to the microprocessor 30 and transferred to the central computer 26 by means of the wireless communication network 10. This data is analyzed by the central computer 26 and used to generate a series of reports in a manner that is known. These reports are used to analyze traffic flows, including in some cases on a real-time basis, for the purpose of resource deployment management. The data is also important from the perspective of tracking “eyeballs” in order to maintain or increase advertising revenue.

In that regard, the microprocessor 30 may be connected to an electronic advertising display means 48 provided at the transit shelters 18. Various electronic advertising displays are known, including for example scrolling signs, flat screen advertising displays and the like. The microprocessor 30 of the present invention is adapted to manage which pieces of advertising are displayed by such electronic advertising displays, when such pieces of advertising are displayed, and for how long such pieces of advertising are displayed. The microprocessor 30 of the present invention therefore comprises an efficient means for administering the delivery of advertising content to transit shelters, as well as generating reports regarding same for the purposes of billing advertising customers.

The microprocessor 30 may be further connected to a known transit rider input device 50. This input device 50 may be combined with the shelter display 34 in a manner that is well known by using a touch screen. Alternatively, a separate input device such as a screen combined with a key board can be used. The purpose of the input device 50 is to solicit input from transit riders, in accordance with the instructions, for example, of marketing companies which are then provided to the control computers 30 by means of instructions from central computer 26, in a manner that is known. Transit riders waiting in transit shelters constitute an attractive pool for such marketing companies, for example, for the purpose of soliciting survey responses. This is because transit riders are in relative terms a “captive audience”, and more importantly, because the time spent waiting is not generally otherwise usefully engaged, and therefore there may be a greater response ratio to such surveys from transit riders than in the general population. Microprocessor 30 of the present invention will administer the delivery of such marketing driven requests for information such as surveys, as well as the delivery of the results to the central computer 26 for processing in a manner that is known.

The present invention further provides means for using the video cameras 44 for security or police surveillance of the vicinity of the transit shelters. This is achieved by placing video cameras 44 in positions to record events in the desired area around the transit shelter 12. The present invention provides means for providing data collected by the video cameras 44 as an audio-video feed to police or other organizations via the wireless communication network 10.

It should be understood that the present invention contemplates the use of alternate AVL systems provided that such systems permit the communication with the driver of the transit vehicles 18 and further permit the monitoring of transit vehicle progress between transit stops. The invention contemplates the use of the present system with additional features of various systems for monitoring and managing transit traffic.

It should be further understood that the present invention contemplates communication between a central computer and transit shelters in association with, one, more or all of the various devices described herein.

Thus, the central computer 26 is programmed so as to execute the instructions required to monitor the movement of transit vehicles 18 along the transit grid, estimate arrival times in accordance with methods that are known, including communication with transit drivers as described above, and then to communicate the updated arrival times to the microprocessor 30 associated with the transit shelters of the present invention.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

1. A data system for provisioning transit stops in a transit system with data concerning estimated arrival time of a transit vehicle at a specific transit stop, wherein said transit system comprises a plurality of transit vehicles, each having its own unique identity, and a plurality of specific transit stops at which any specific transit vehicle scheduled to stop from time to time; characterized by:
a central computer;
at least a microprocessor at each individual transit stop, each having its own identity whereby each transit stop has its own identity, whereby each transit stop has its own unique identity;
first communication means at each transit stop, adapted to communicate with said central computer so as to selectively send data thereto and receive data therefrom;
second communication means on each transit vehicle, adapted to communicate with said central computer so as to transmit data thereto which are indicative of the present location or driving conditions for each specific transit vehicle at any instant in time;
a security activator at each transit stop adapted to transmit a signal to said central computer that an emergency situation exists at that respective transit stop, when activated; and
annunciator means at each transit stop adapted to provide visual and/or audible announcements to transit riders thereat;
wherein said central computer is adapted to analyse the present location or driving condition data for any specific transit vehicle and to transmit data to a specific transit stop concerning the then estimated arrival time of a specific transit vehicle to that specific transit stop, at any instant in time; and
wherein said central computer is adapted to receive a signal indicating an emergency situation at any specific transit stop at any instant in time, and to notify public authorities of that emergency situation.

2. The data system of claim 1, wherein said microprocessor, first communication means, security actuator, and annunciator means, for any specific transit stop, are located in a secure, tamper-proof, enclosure.

3. The data system of claim 1, wherein said enclosure is integrally associated with a transit shelter.

4. The data system of claim 2, wherein at least selected transit vehicles are equipped with GPS apparatus so as to have real time updating of their present location.

5. The data system of claim 2, wherein at least selected transit stops are equipped with a microphone and a voice annunciator, whereby two-way voice communication can be conducted between any such selected transit stop and an operator who is present at said central computer.

6. The data system of claim 1, wherein communication between any transit stop and said central computer is by a communications method chosen from the group consisting of wired telephone communication, radio-operated wireless communication, mobile telephone communication, and computer network communication, and wherein each transit stop has a unique telephone number or IP address as necessary.

7. The data system of claim 2, wherein any transit stop is equipped with at least one further security or rider amenity feature chosen from the group consisting of vibration sensors to sense vibration as a consequence of vandalism or accident, impact sensors to sense motion as a consequence of vandalism or accident, surveillance cameras, video cameras, proximity sensors to sense the presence of persons in the immediate vicinity of the respective transit shelter, controllably beacons, controllable illumination lamps, video display means, alphanumeric display means, and mixtures and combination thereof

8. The data system of claim 3, wherein any transit shelter is equipped with at least one further security or rider amenity feature chosen from the group consisting of vibration sensors to sense vibration as a consequence of vandalism or accident, impact sensors to sense motion as a consequence of vandalism or accident, surveillance cameras, video cameras, proximity sensors to sense the presence of persons in the immediate vicinity of the respective transit shelter, controllably beacons, controllable illumination lamps, glass breakage sensors, video display means, alphanumeric display means, and mixtures and combination thereof.

9. The data system of claim 7, wherein any transit stop further comprising a rider presence indicator to indicate to the driver of an approaching transit vehicle that at least one rider awaits the arrival of that transit vehicle at that specific transit stop.

10. The data system of claim 8, wherein any transit shelter further comprising a rider presence indicator to indicate to the driver of an approaching transit vehicle that at least one rider awaits the arrival of that transit vehicle at that specific transit stop.

11. The data system of claim 7, wherein any transit stop further comprises means for providing or receiving fare vouchers or specific fare payments from transit riders at that transit stop.

12. The data system of claim 8, wherein any transit stop further comprises means for providing or receiving fare vouchers or specific fare payments from transit riders at that transit shelter.

13. The data system of claim 7, wherein any transit stop further comprises annunciator means to indicate the imminent arrival of a transit vehicle at that transit stop.

14. The data system of claim 8, wherein any transit stop further comprises annunciator means to indicate the imminent arrival of a transit vehicle at that transit shelter.

15. The data system of claim 7, wherein said video or alphanumeric display means in adapted to display schedule information of transit vehicles intended to come to that transit stop, under the control of the microprocessor at that transit stop and said central computer;
whereby said schedule information is updated by said central computer is real time.

16. The data system if claim 8, wherein said video or alphanumeric display means in adapted to display schedule information of transit vehicles intended to come to that transit shelter, under the control of the microprocessor at that transit shelter and said central computer;
whereby said schedule information is updated by said central computer is real time.

17. The data system of claim 2, wherein any transit stop further comprises air quality sensor means for sensing and analysing ambient air in the immediate vicinity of that transit stop, in real time.

18. The data system of claim 3, wherein any transit shelter further comprises air quality sensor means for sensing and analysing ambient air in the immediate vicinity of that transit shelter, in real time.
